(19) United States
(12) Patent Application Publication
(10) Pub. No.: US 2024/0330647 A1
(43) Pub. Date: Oct. 3, 2024

(54) METHOD AND APPARATUS FOR SEARCHING GRAPH OF DEEP LEARNING MODEL

(71) Applicant: Korea University Research and Business Foundation, Seoul (KR)

(72) Inventors: Seon Wook Kim, Namyangju-si (KR); Seok-Young Kim, Seoul (KR); Jae Wook Lee, Seoul (KR)

(21) Appl. No.: 18/400,227

(22) Filed: Dec. 29, 2023

(30) Foreign Application Priority Data
Apr. 3, 2023 (KR) 10-2023-0043576

(51) Int. Cl. G06N 3/042

(52) U.S. Cl. CPC G06N 3/042

(57) ABSTRACT

A method of searching a graph of a deep learning model includes initializing profile-related information added to attribute information of each of vertices constituting the graph; performing topological sorting on the vertices and searching for a corresponding vertex in order of topological sort; deriving, when the search is completed, profile-related information of the corresponding vertex on the basis of profile-related information of a predecessor vertex of the corresponding vertex and incoming edge information of the corresponding vertex; updating attribute information of the corresponding vertex; and outputting path information when all edges different from each other constituting the graph are searched on a path from a starting point of the graph to the corresponding vertex. With a graph search using a proposed data structure, the minimum number of times of execution including edges to be searched and a path at this point are obtained within a polynomial time.

### CROSS-REFERENCE TO RELATED APPLICATION

The present application claims the benefit of priority to Korean Patent Application No. 10-2023-0043576, filed on Apr. 3, 2023 in the Korean Intellectual Property Office, the entire content of which is incorporated herein by reference.

### BACKGROUND OF THE INVENTION

### Field of the Invention

The present invention relates to a method and apparatus for searching a graph of a deep learning model, and particularly to, a method and apparatus for searching a graph, which minimizes profiling overheads of a deep learning model on the basis of edge information of the graph.

### Background of the Related Art

Artificial Neural Network (ANN) techniques are proposed to imitate human brains using computers and configured of perceptrons that model human nerve cells. The perceptron performs operation in multiple input data layers and sends calculated data to the output data layer. At this point, machine learning means updating the weight value of the perceptron through a forward/backward propagation process and learning the input data. However, as the input data including images, languages, and the like has become more complicated recently, there is a limitation in learning the input data through only single-layer perceptrons, and in order to overcome this problem, deep learning techniques, which are algorithms improving accuracy of machine learning by arranging perceptrons in multiple layers, are spotlighted.

Such a deep learning model may be expressed as a graph, and graph G(V,E) is configured of a set of vertices V representing deep learning operators and a set of edges E representing dependencies between the deep learning operators.

Meanwhile, when the number of vertices and edges constituting the graph increases greatly, partitioning of graph is performed to improve performance, availability, and the like of the deep learning model, and for the sake of the graph partitioning, profiling of the deep learning model should be preceded. That is, the cost defined at the vertices and edges, i.e., execution time, should be measured by performing the profiling through a single path from the starting point to the ending point of the graph of deep learning model, and the graph partitioning may be performed using results of the measurement. In addition, optimal execution of the deep learning model may be achieved by determining vertices and computing devices to be assigned with the vertices through graph partitioning in a heterogeneous platform including various computing devices such as a Central Processing Unit (CPU), a Graphic Processing Unit (GPU), and the like.

However, as complexity of the graph of a deep learning model increases, the number of vertices and edges constituting the graph also increases, and since the time complexity of listing all paths from a starting point to an ending point in the graph G(V,E) is O(V!), and the time complexity of confirming whether the edges to be searched are included is O(E), there is a problem in that graph search may not be completed within a polynomial time as measuring the cost V_{cost} of all vertices and the cost E_{cost} of all edges increases profiling overheads.

Accordingly, techniques that can reduce the profiling overheads of the deep learning model graphs are required.
(Patent Document 0001) Korean Patent Publication No. 10-2023-0001132

### SUMMARY OF THE INVENTION

Therefore, the present invention has been made in view of the above problems, and it is an object of the present invention to provide a method and apparatus for searching a graph of a deep learning model and minimizing profiling overheads on the basis of edge information of the graph.

To accomplish the above object, according to one aspect of the present invention, there is provided a method of searching a graph of a deep learning model, the method comprising the steps of: initializing, when the graph of a deep learning model is input, profile-related information added to attribute information of each of vertices constituting the graph; performing topological sorting on the vertices and searching for a corresponding vertex in order of topological sort; deriving, when the search is completed, profile-related information of the corresponding vertex on the basis of profile-related information of a predecessor vertex of the corresponding vertex and incoming edge information of the corresponding vertex; updating attribute information of the corresponding vertex; and outputting path information when all edges different from each other constituting the graph are searched on a path from a starting point of the graph to the corresponding vertex.

To accomplish the above object, according to another aspect of the present invention, there is provided an apparatus for searching a graph of a deep learning model, the apparatus comprising: an input unit for receiving the graph of a deep learning model; a process for initializing profile-related information added to attribute information of each of vertices constituting the graph, performing topological sorting on the vertices, searching for a corresponding vertex in order of topological sort, deriving, when the search is completed, profile-related information of the corresponding vertex on the basis of profile-related information of a predecessor vertex of the corresponding vertex and incoming edge information of the corresponding vertex, and updating attribute information of the corresponding vertex; and an output unit for outputting path information when all edges different from each other constituting the graph are searched on a path from a starting point of the graph to the corresponding vertex.

According to one aspect of the present invention described above, as the present invention provides a method and apparatus for searching a graph on the basis of edge information of the graph when searching a graph of a deep learning model, a minimum number of times of execution including edges to be searched, starting from a starting point to an ending point of the graph, and the path at this time can be obtained within a polynomial time, and thus profiling overheads can be minimized.

In addition, in comparison with the conventional graph search method that performs profiling only for some combinations by simplifying all paths and the costs associated with them, the graph search method proposed in the present invention has an effect of providing an accurate profiling result of graph partitioning since graph search is performed on the entire graph.

### BRIEF DESCRIPTION OF THE DRAWINGS

FIG. 1A is a view showing attribute information of vertices and edges constituting a graph of a deep learning model.

FIG. 1B is a view showing an example of a graph of a deep learning model.

FIG. 2 is a view showing attribute information of vertices constituting a graph of a deep learning model according to an embodiment of the present invention, and an example of performing graph search using the attribute information.

FIGS. 3A to 3G are views showing an example of searching a graph of a deep learning model over time according to an embodiment of the present invention.

FIG. 4 is a view showing an example of pseudo code of a graph search algorithm of a deep learning model according to an embodiment of the present invention.

FIG. 5 is a flowchart illustrating the operation of searching a graph of a deep learning model according to an embodiment of the present invention.

FIG. 6 is a block diagram showing an apparatus for searching a graph of a deep learning model according to an embodiment of the present invention.

### DETAILED DESCRIPTION OF THE PREFERRED EMBODIMENT

The detailed description of the present invention described below refers to accompanying drawings which show specific embodiments in which the present invention may be practiced as an example. These embodiments are described in detail to be sufficient for those skilled in the art to embody the present invention. It should be understood that various embodiments of the present invention are not necessarily mutually exclusive although they are different from each other. For example, specific shapes, structures, and characteristics described herein may be implemented as different embodiments without departing from the spirit and scope of the present invention. In addition, it should be understood that the locations or arrangements of individual components within each disclosed embodiment may be changed without departing from the spirit and scope of the present invention. Accordingly, the detailed description described below is not to be taken in a limiting sense, and the scope of the present invention, if properly described, is limited only by the appended claims, together with all the scopes equivalent to those claimed in the claims. Like reference numerals in the drawings indicate the same or similar functions throughout various aspects.

Components according to the present invention are components defined not by physical classification but by functional classification, and may be defined by the functions performed by each component. Each component may be implemented as hardware or program codes and processing units that perform respective functions, and functions of two or more components may be implemented to be included in one component. Therefore, the names given to the components in the following embodiments are not to physically distinguish each component, but to imply a representative function performed by each component, and it should be noted that the technical spirit of the present invention is not limited by the names of the components.

Hereinafter, preferred embodiments of the present invention will be described in more detail with reference to the drawings.

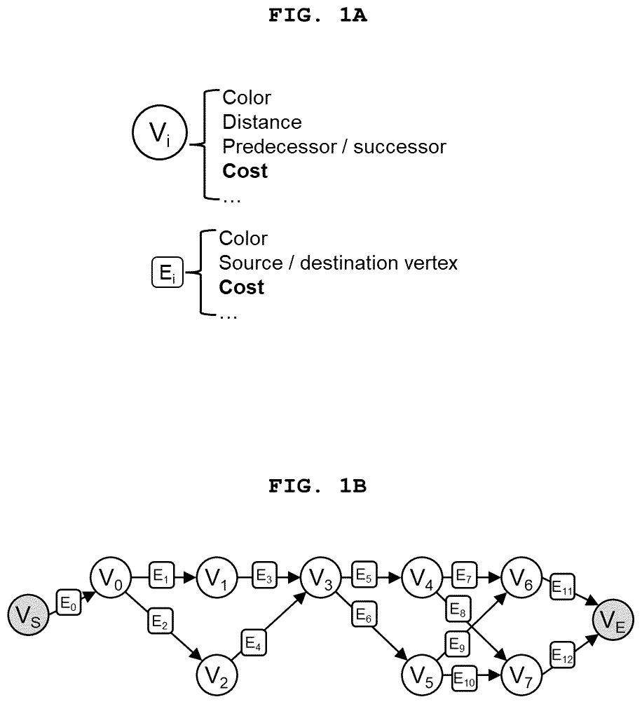

FIG. 1A is a view showing attribute information of vertices and edges constituting a graph of a deep learning model, and FIG. 1B is a view showing an example of a graph of a deep learning model.

Referring to FIG. 1A, graph G(V,E) of a deep learning model is configured of a set of vertices V representing deep learning operators and a set of edges E representing dependencies between the deep learning operators, and at this point, attribute information of vertex Vᵢ includes color information indicating enqueue/dequeue of the vertex, distance information from the starting point V_{S} to Vᵢ, predecessor/successor information in a directed graph, cost information, and the like. The cost information among the attribute information of Vᵢ may be defined as an execution time when the corresponding vertex performs a deep learning operator.

The attributes of edge Eᵢ include color information, source and destination vertex information, cost information, and the like. Among the attribute information of Eᵢ, the cost information may be defined as a time required for data transmission from a source vertex to a destination vertex.

Referring to FIG. 1B, the graph shows an example of a graph configured of 8 vertices from V₀ to V₇ and 13 edges from E₀ to E₁₂, and may include a plurality of paths from the starting point V_{S} to the ending point V_{E}. The paths are defined as a sequence of vertices from the starting point V_{S} to the ending point V_{E}, and for example, path V_{S}→V₀→V₂→V₃→V₅→V₇→V_{E} includes edges E₀, E₂, E₄, E₆, E₁₀, and E₁₂.

In the case of the graph shown in FIG. 1B, all eight paths should be searched to determine whether the edges to be searched have been searched, and therefore, eight times of execution are required to obtain profiling information of the edges to be searched.

In an embodiment of the present invention described below, a method of adding a separate data structure to the attributes of vertices and performing graph search using the structure will be explained.

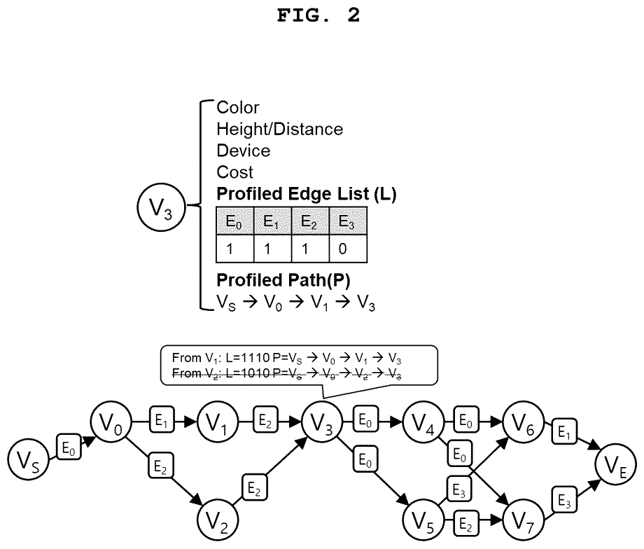

FIG. 2 is a view showing attribute information of vertices constituting a graph of a deep learning model according to an embodiment of the present invention, and an example of performing graph search using the attribute information.

Referring to FIG. 2, the graph shown in FIG. 2 is assumed as a graph configured of 8 vertices and 13 edges, and as the purpose of profiling is to measure the cost of the vertices and edges constituting the graph, edges having the same cost are considered as the same edges. Here, the same cost means that the time required to transmit data from a source vertex to a destination vertex is the same. Therefore, although the graph shown in the figure is assumed to be the same as the graph shown in FIG. 1B, it is shown that edges E₅, E₆, E₇, and E₈ having the same cost as E₀ are replaced with E₀, and edge E₁₁ having the same cost as E₁ is replaced with E₁, edges E₄ and E₁₀ having the same cost as E₂ are replaced with E₂, and edges E₉ and E₁₂ having the same cost as E₃ are replaced with E₃.

In the present invention, a profiled edge list L expressing whether the edges to be searched in the graph have been searched in the form of a list, and a profiled path P expressing the path from the starting point V_{S} to vertex Vᵢ corresponding to the profiled edge list are newly defined. Profiled edge list L and profiled path P are defined as profiled-related information. The profiled edge list L has indices corresponding to the number of edges to be searched, and the index value may be set to 0 or 1. When the index value is set to 1, it means that the edge corresponding to the index has been searched on the path from the starting point S to vertex Vᵢ, and when the index value is set to 0, the edge corresponding to the index has not been searched on the path. In addition, information on the profiled edge list L and information on the profiled path P are added to the attribute information of the graph vertices as a separate data structure.

For example, information on the attributes of vertex V₃ is described below. The attribute information of vertex V₃ includes color information, distance information, predecessor/successor information, cost information, profiled edge list L information, and profiled path P information. Since there are a total of four different edges to be searched in the graph shown in the figure, the length of the profiled edge list is 4, and indices of the profiled edge list L include E₀, E₁, E₂, and E₃. Since the value of the profiled edge list L of vertex V₃ is [1110], it can be seen that edges E₀, E₁, and E₂ have been searched on the path from the starting point V_{S} to vertex V₃.

Describing vertex V₃ at a specific time point, there are a first path of V_{S}→V₀→V₁→V₃ and a second path of V_{S}→V₀→V₂→V₃ between the starting point V_{S} and vertex V₃, and at this point, the profiled edge list of the first path is L=1110, and the profiled edge list of the second path is L=1010. Comparing the inclusion relation between the profiled edge lists of the first path and the second path, when the profiled edge list of the first path is L(V₁) and the profiled edge list of the second path is L(V₂), since the value of L(V₁) is [1110] and the value of L(V₂) is [1010], the value of L(V₁) [1110] corresponding to the superset among the two values and the path V_{S}→V₀→V₁→V₃ corresponding to L (V₁) are stored in the attribute information of vertex V₃.

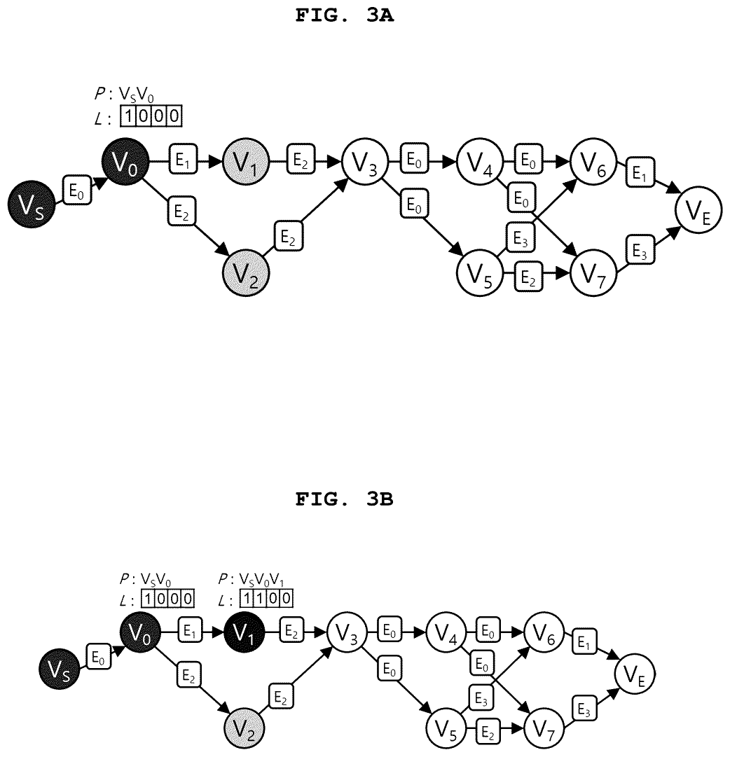

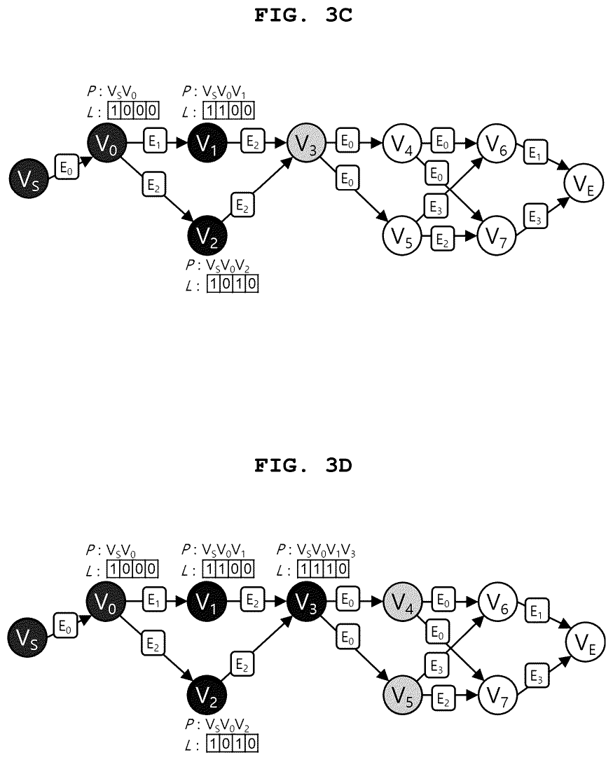

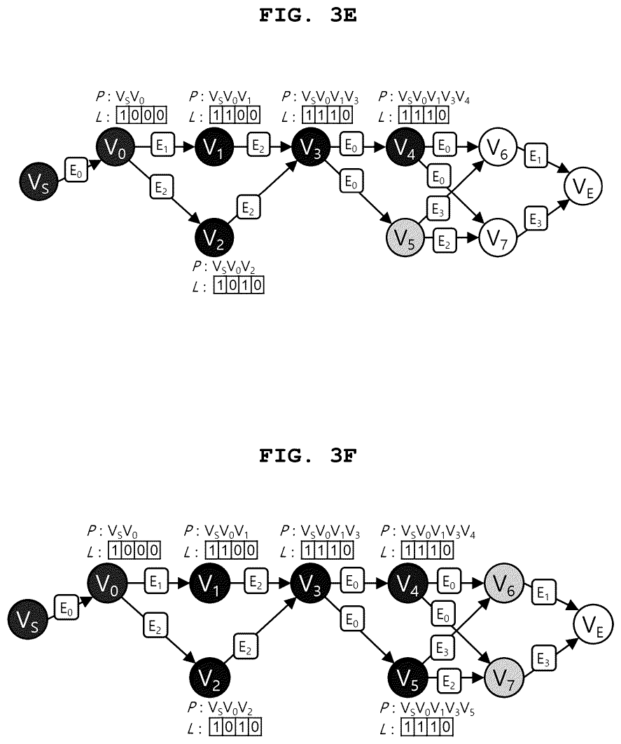

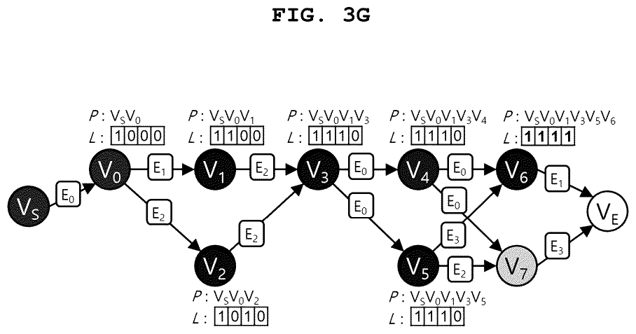

The operation of graph search at a specific time point has been described in FIG. 2 as an example. Hereinafter, an example of searching a graph over time for the same graph as the graph shown in FIG. 2 will be described with reference to FIGS. 3A to 3G.

FIGS. 3A to 3G are views showing an example of searching a graph of a deep learning model over time according to an embodiment of the present invention.

Before describing FIGS. 3A to 3G, a graph search method according to an embodiment of the present invention will be described briefly as follows. The profiled edge list L and profiled path P information among the attribute information are initialized for all vertices V₀ to V₇ constituting the graph, and topological sorting is performed on the vertices. Here, it is assumed that the vertices are topologically sorted in order of V₀, V₁, V₂, V₃, V₄, V₅, V₆, and V₇.

Graph search is performed in order of topological sort using a First Input First Output (FIFO) queue. At this point, all the vertices are initially set to white, and when a vertex is searched, the vertex is enqueued and set to gray, and when search is completed, the vertex is dequeued and set to black. A profiled edge list L (Vᵢ) for vertex Vᵢ and a profiled path P (Vᵢ) corresponding thereto are obtained using incoming edge information of vertex Vᵢ dequeued during the graph search and vertex information of the predecessor, and through this, attribute information of vertex Vᵢ is updated. When all the values of L(Vᵢ) are 1, graph search is terminated.

Seeing the graph search process at time TO shown in FIG. 3A, when search of vertex V₀ is completed, vertex V₀ is dequeued and set to black. Since incoming edge E₀ of vertex V₀ is searched, the values of indices E₀, E₁, E₂, and E₃ of L(V₀) are set to [1000], and L (V₀) value [1000] and P (V₀) information V_{S}V₀ from the starting point V_{S} to vertex V₀ corresponding thereto are stored in V₀ and update the attribute information.

Seeing the graph search process at time T1 shown in FIG. 3B, when search of vertex V₁ among vertices V₁ and V₂ enqueued at T₀ is completed in order of topological sort, vertex V₁ is dequeued and set to black. Since incoming edge E₁ of vertex V₁ is searched, L(V₁) value [1100] is obtained by changing only the index value of edge E₁ searched on the basis of L(V₀) value [1000] of predecessor vertex V₀ to ‘1’, and L(V₁) value [1100] and P(V₁) information V_{S}V₀V₁ from the starting point V_{S} to vertex V₁ corresponding thereto are stored in vertex V₁ and update the attribute information. Although L(V₀) value [1000] of predecessor vertex V₀ is changed to ‘1’ since the index value of the searched edge E₁ is ‘0’, when the index value of edge E₁ is ‘1’, the value is maintained. This case will be described again in the graph search process at time T4.

Seeing the graph search process at time T2 shown in FIG. 3C, when search of vertex V₂ is completed, vertex V₂ is dequeued and set to black. Since incoming edge E₂ of vertex V₂ is searched, L(V₂) value [1010] is obtained by changing only the index value of edge e₂ searched on the basis of L(V₀) value [1000] of predecessor vertex V₀ to ‘1’, and L (V₂) value [1010] and P (V₂) information V_{S}V₀V₂ from the starting point V_{S} to vertex V₂ corresponding thereto are stored in vertex V₂ and update the attribute information.

Seeing the graph search process at time T3 shown in FIG. 3D, when search of vertex V₃ enqueued at time T2 is completed, vertex V₃ is dequeued and set to black. Since vertex V₃ has two incoming edges, there are also two predecessor vertices that are considered when the value of L(V₃) is derived. Therefore, after obtaining a first candidate value [1110] derived on the basis of L(V₁) value [1100] of predecessor vertex V₁ and information on the searched edge E₂ and a second candidate value [1010] derived on the basis of L(V₂) value [1010] of predecessor vertex V₂ and information on the searched edge E₂, the inclusion relation between the first candidate value and the second candidate value is determined. As a result of the determination, the first candidate value [1110] corresponding to the superset (subset) is derived as L(V₃) value, and P(V₃) information V_{S}V₀V₁V₃ from the starting point V_{S} to the vertex V₃ corresponding thereto is derived. In addition, L(V₃) value [1110] and P(V₃) information V_{S}V₀V₁V₃ are stored in vertex V₃ and update the attribute information.

Seeing the graph search process at time T4 shown in FIG. 3E, when search of vertex V₄ among V₄ and V₅ enqueued at T3 is completed, vertex V₄ is dequeued and set to black. Since incoming edge E₀ of vertex V₄ is searched, the index value of the searched edge E₀ is confirmed on the basis of L(V₃) value [1110] of predecessor vertex V₃, and since the index value of the searched edge E₀ is already set to ‘1’, L(V₃) value [1110] is inherited as is, and attribute information of vertex V₄ is updated. In addition, the attribute information of vertex V₄ is updated with P(V₄) information V_{S}V₀V₁V₃V₄ from the starting point V_{S} to vertex V₄ corresponding to L(V₄) value [1110].

Seeing the graph search process at time T5 shown in FIG. 3F, when search of vertex V₅ is completed, vertex V₅ is dequeued and set to black. Since incoming edge E₀ of vertex V₅ is searched, the index value of the searched edge E₀ is confirmed on the basis of L(V₃) value [1110] of predecessor vertex V₃, and since the index value of the searched edge E₀ is already set to ‘1’, L(V₃) value
of predecessor vertex V₃ is inherited as is, and attribute information of vertex V₅ is updated. In addition, the attribute information of vertex V₅ is updated with P (V₅) information V_{S}V₀V₁V₃V₅ from the starting point V_{S} to vertex V₅ corresponding to the L(V₅) value [1110].

Seeing the graph search process at time T6 shown in FIG. 3G, when search of vertex V₆ among V₆ and V₇ enqueued at T5 is completed, vertex V₆ is dequeued and set to black. Since vertex V₆ has two incoming edges, after obtaining a value [1110] calculated by confirming the index value of edge E₀ searched on the basis of L(V₄) value [1110] of predecessor vertex V₄ and a value [1111] calculated by confirming the index value of edge E₃ searched on the basis of L(V₅) value [1110] of predecessor vertex V₅, the inclusion relation between the [1110] and the [1111] is determined. As a result of the determination, the attribute information of vertex V₆ is updated with the value [1111] corresponding to the superset, and attribute information of vertex V₆ is updated with P(V₆) information V_{S}V₀V₁V₃V₅V₆ from the starting point V_{S} to vertex V₆ corresponding thereto. At this point, as L(V₆) value is [1111] and thus all the edges constituting the graph have been searched, the graph search is terminated, and the path including all the edges that have been searched, i.e., P (V₆) information V_{S}V₀V₁V₃V₅ from the starting point V_{S} to the vertex V₆, is output.

As described above, as profiled edge list information indicating whether edges to be searched have been searched and profiled path information corresponding thereto are added to the attribute information of a vertex, the graph search method proposed in the present invention may obtain the minimum number of times of execution including edges to be searched, starting from a starting point to an ending point of the graph, and the path at this time within a polynomial time using the added profile information when the graph is searched.

In addition, as only graphs having as many vertices as V and as many edges as E are searched and inclusion relation of as many different profiled edge lists as E is determined at a vertex, the overall time complexity of the algorithm may be expressed as O(V+E*E)=O(V+E²), and profiling overheads is also reduced due to decrease in time complexity.

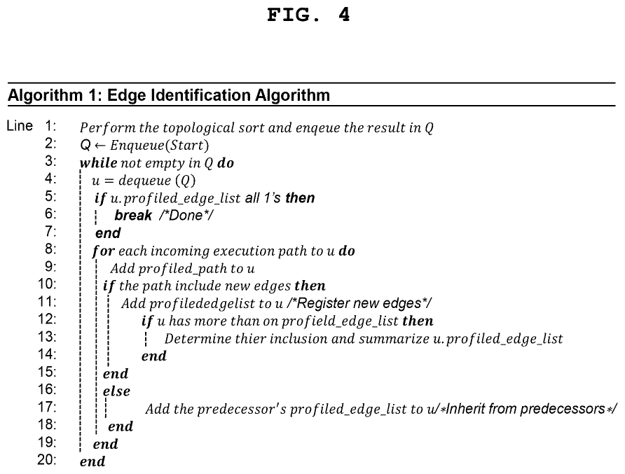

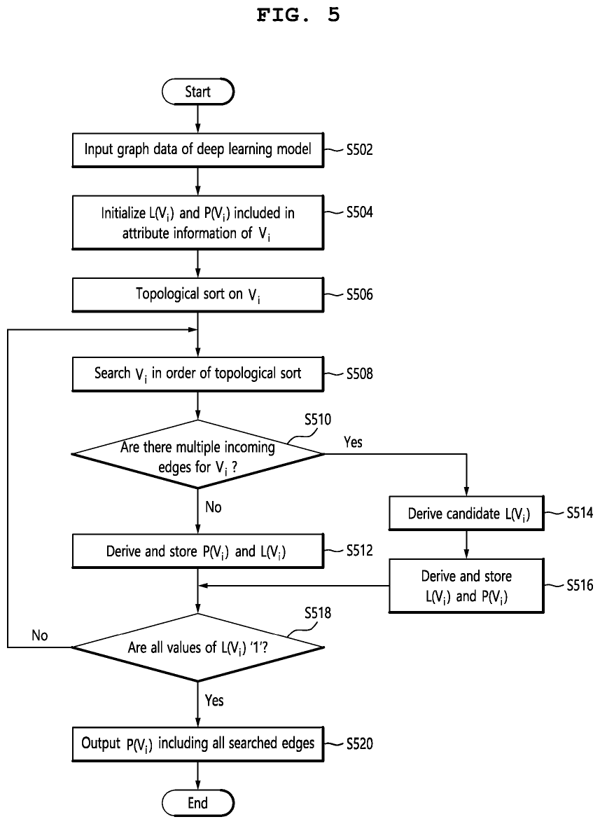

FIG. 4 is a view showing an example of pseudo code of a graph search algorithm of a deep learning model according to an embodiment of the present invention.

Referring to FIG. 4, the illustrated pseudo code shows an edge identification algorithm included in the graph search algorithm.

Line 1 indicates that topological sorting is performed and a result thereof is enqueued in the queue Q, and line 2 indicates that the algorithm begins when the vertices are enqueued in the queue.

Lines 3, 4, and 20 indicate that the operation of dequeuing vertices from the queue is repeated until the queue is emptied.

Lines 5 to 7 indicate that whether all the values in the profiled edge list of a dequeued vertex are ‘1’ is confirmed, and when all the values are ‘1’, the algorithm is terminated.

Lines 8, 9, and 19 indicate that each time a new vertex is searched, a profiled edge list and a profiled path are created and stored in the attribute of the new vertex.

Lines 10, 11, and 15 indicate that when a new edge is added to the path from the starting point to a corresponding vertex, information on the new edge is added to the profiled edge list.

Lines 12 to 14 indicate that when two or more incoming edges are connected to a corresponding vertex to have two or more profiled edge lists, one profiled edge list is determined by determining the inclusion relation between the profiled edge lists.

Lines 16 to 18 indicate that when there is no new edge in the path from the starting point to a corresponding vertex, the profiled edge list of the predecessor vertex is inherited.

FIG. 5 is a flowchart illustrating the operation of searching a graph of a deep learning model according to an embodiment of the present invention.

Referring to FIG. 5, when graph data of a deep learning model is input (S502), the graph search apparatus according to an embodiment of the present invention initializes the profiled edge list L(Vᵢ) and the profiled path P(Vᵢ) included in the attribute information of vertex Vᵢ constituting the input graph (S504). Then, topological sorting is performed on vertex Vᵢ (S505), and Vᵢ is searched in order of topological sort (S508).

At S510, the graph search apparatus confirms whether there are multiple incoming edges of Vᵢ on which the search has been completed, and when there are no multiple incoming edges of Vᵢ, it proceeds to S512 to derive and store a profiled edge list L(Vᵢ) and a profiled path P(Vᵢ) on the basis of the profiled edge list L and the incoming edge information of the predecessor vertex.

On the other hand, when there are multiple incoming edges of Vᵢ as a result of the confirmation at S510, the process proceeds to S514 to derive a candidate profiled edge list L(Vᵢ) for each incoming edge on the basis of the profiled edge list L and the incoming edge information of the predecessor vertex. Here, the number of candidates L(Vᵢ) is equal to the number of incoming edges of Vᵢ. Then, the inclusion relation between the candidates L(Vᵢ) is determined, and L(Vᵢ) corresponding to the superset and P(Vᵢ) corresponding thereto are derived and stored (S516).

At S518, the graph search apparatus confirms whether all the values of the stored profiled edge list L(Vᵢ) are ‘1’. When all the values of L(Vᵢ) are ‘1’ as a result of the confirmation at S518, the graph search apparatus determines that all the edges have been searched, proceeds to S520 and outputs the stored P(Vᵢ), i.e., P(Vᵢ) of which all edges have been searched, and terminates graph search.

On the other hand, when all the values of L(Vᵢ) are not ‘1’ as a result of the confirmation at S518, the process proceeds to S508 to search for a next Vᵢ.

It has been described in an embodiment of the present invention as an example that the index values of the profiled edge list L(Vᵢ) are set to 0 or 1 to indicate whether the edge has been searched for. However, whether or not an edge has been searched for may be determined by a predetermined specific value, and in this case, S518 may be replaced with a step of confirming whether the value of the profiled edge list L(Vᵢ) satisfies a specific value indicating that all the edges have been searched.

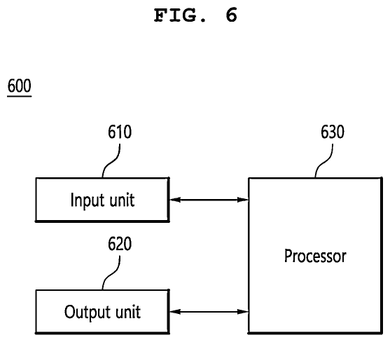

FIG. 6 is a block diagram showing an apparatus for searching a graph of a deep learning model according to an embodiment of the present invention.

Referring to FIG. 6, the graph search apparatus 600 according to an embodiment of the present invention includes an input unit 610, an output unit 620, and a processor 630.

The graph search apparatus 600 receives graph data of a deep learning model through the input unit 610 and performs graph search through the processor 630. That is, the graph search apparatus 600 initializes the profiled edge list L(Vᵢ) and the profiled path P(Vᵢ) included in the attribute information of vertex Vᵢ constituting the input graph, performs topological sorting on vertex Vᵢ, and searches Vᵢ in order of topological sort.

In addition, when there are no multiple incoming edges of Vᵢ for which the search has been completed through the processor 630, the graph search apparatus derives and stores a profiled edge list L(Vᵢ) and a profiled path P(Vᵢ) on the basis of the profiled edge list L and the incoming edge information of the predecessor vertex. In addition, when there are multiple incoming edges of Vᵢ for which the search has been completed, the graph search apparatus derives candidate profiled edge lists L(Vᵢ) corresponding to the number of incoming edges on the basis of the profiled edge list L and the incoming edge information of the predecessor vertex for each incoming edge, determines the inclusion relation between the candidates L(Vᵢ), and derives and stores L(Vᵢ) corresponding to the superset and P(Vᵢ) corresponding thereto.

In addition, when all the values of the stored edge list L(Vᵢ) are ‘1’, the graph search apparatus outputs stored P(Vᵢ), i.e., P(Vᵢ) including all the edges that have been searched, through the output unit 620, and terminates graph search. In addition, when all the values of the stored edge list L(Vᵢ) are not ‘1’, the graph search apparatus searches for a next Vᵢ in order of topological sort through the processor 630.

The graph search method proposed in the present invention as described above may be implemented in the form of program instructions that can be executed through various computer components and recorded in a computer-readable recording medium. The computer-readable recording medium may store program instructions, data files, data structures, and the like alone or in combination.

The program instructions recorded in the computer-readable recording medium may be specially designed and configured for the present invention or may be known to and used by those skilled in the field of computer software.

Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program instructions, such as ROM, RAM, flash memory, and the like.

Examples of the program instructions include high-level language codes that can be executed by a computer using an interpreter, as well as machine language codes such as those produced by a compiler. The hardware devices described above may be configured to operate as one or more software modules to perform the processes according to the present invention, and vice versa.

Although various embodiments of the present invention have been shown and described above, the present invention is not limited to the specific embodiments described above, and of course, various modified embodiments are possible by those skilled in the art without departing from the gist of the present invention claimed in the claims, and these modified embodiments should not be individually understood from the technical spirit or prospect of the present invention.

### DESCRIPTION OF SYMBOLS

600: Graph search apparatus

What is claimed is:

1. A method of performing a graph search in a deep learning model, the method performed at least in part by a processor and comprising:
initializing profile-related information (a profiled edge list L and a profiled path P) added to attribute information of each of vertices constituting the graph;
performing a topological sort on the vertices, and searching for a corresponding vertex in order of the topological sort;
deriving profile-related information of the corresponding vertex on the basis of:
profile-related information of a predecessor vertex of the corresponding vertex in the order of the topological sort, and
incoming edge information of the corresponding vertex;
updating the attribute information of the corresponding vertex with the derived profile-related information; and
when all edges different from each other and constituting the graph have been searched, outputting path information on a path from a starting point of the graph to the corresponding vertex, based on the updated attribute information.

2. The method according to claim 1, wherein the profile-related information includes:
profiled edge list information indicating whether all the edges have been searched, and
profiled path information indicating the path from the starting point to the corresponding vertex.

3. The method according to claim 2, wherein, when there is only one incoming edge for the corresponding vertex, the deriving includes:
deriving the profiled edge list information and the profiled path information of the corresponding vertex on the basis of:
the profiled edge list information of the predecessor vertex, and
incoming edge information of the predecessor vertex.

4. The method according to claim 2, wherein, when there are multiple incoming edges for the corresponding vertex, the deriving includes:
deriving, for each incoming edge among the multiple incoming edges, candidate profiled edge list information on the basis of:
the profiled edge list information of the predecessor vertex corresponding to said each incoming edge, and
incoming edge information of the predecessor vertex corresponding to said each incoming edge,
determining an inclusion relation of the candidate profiled edge list information of the multiple incoming edges, and
deriving the profiled edge list information and the profiled path information of the corresponding vertex on the basis of a superset of the candidate profiled edge list information of the multiple incoming edges in accordance with the inclusion relation.

5. The method according to claim 2, further comprising:
terminating the graph search when a value of the profiled edge list satisfies a specific value indicating that all the edges have been searched.

6. An apparatus for a graph search in a deep learning model, the apparatus comprising:
a processor configured for:
initializing profile-related information added to attribute information of each of vertices constituting the graph,
performing a topological sort on the vertices, and searching for a corresponding vertex in order of the topological sort,
deriving profile-related information of the corresponding vertex on the basis of:
profile-related information of a predecessor vertex of the corresponding vertex in the order of the topological sort,
and incoming edge information of the corresponding vertex,
updating the attribute information of the corresponding vertex with the derived profile-related information, and
when all edges different from each other and constituting the graph have been searched, outputting path information on a path from a starting point of the graph to the corresponding vertex, based on the updated attribute information.

7. The apparatus according to claim 6, wherein the profile-related information includes:
profiled edge list information indicating whether all the edges have been searched, and
profiled path information indicating the path from the starting point to the corresponding vertex.

8. The apparatus according to claim 7, wherein, when there is only one incoming edge for the corresponding vertex, the processor is configured to:
derive the profiled edge list information and the profiled path information of the corresponding vertex on the basis of:
the profiled edge list information of the predecessor vertex, and
the incoming edge information of the predecessor vertex.

9. The apparatus according to claim 7, wherein, when there are multiple incoming edges for the corresponding vertex, the processor is configured to:
derive, for each incoming edge among the multiple incoming edges, candidate profiled edge list information on the basis of:
the profiled edge list information of the predecessor vertex corresponding to said each incoming edge, and
incoming edge information corresponding to said each incoming edge,
determine an inclusion relation of the candidate profiled edge list information of the multiple incoming edges, and
derive the profiled edge list information and the profiled path information of the corresponding vertex on the basis of a superset of the candidate profiled edge list information of the multiple incoming edges in accordance with the inclusion relation.

10. The apparatus according to claim 7, wherein the processor is configured to:
terminate the graph search when a value of the profiled edge list satisfies a specific value indicating that all the edges have been searched.
